(19) United States
(12) Patent Application Publication
(10) Pub. No.: US 2026/0179544 A1
(43) Pub. Date: Jun. 25, 2026

(54) CONTROL ASSEMBLY, METHOD FOR CONTROLLING DISPLAY PANEL, AND DISPLAY APPARATUS

(71) Applicants: Hefei BOE Joint Technology Co., Ltd., Hefei, Anhui (CN); BOE Technology Group Co., Ltd., Beijing (CN)

(72) Inventors: Wenchao BAO, Beijing (CN); Huihui LI, Beijing (CN); Xue QU, Beijing (CN)

(73) Assignees: Hefei BOE Joint Technology Co., Ltd., Hefei, Anhui (CN); BOE Technology Group Co., Ltd., Beijing (CN)

(21) Appl. No.: 18/836,773

(22) PCT Filed: Sep. 18, 2023
(86) PCT No.: PCT/CN2023/119323

§ 371 Date: Aug. 8, 2024

(51) Int. Cl. G09G 3/3225; G09G 3/20

(52) U.S. Cl. CPC G09G 3/3225; G09G 3/2074; G09G 2320/0233; G09G 2320/0242; G09G 2320/041; G09G 2320/045; G09G 2320/0666; G09G 2360/145

(57) ABSTRACT

The present application discloses a control assembly, a method for controlling a display panel, and a display apparatus, and belongs to the field of display technologies. The control assembly is configured to: acquire brightness parameters of sub-pixels of all colors in a previous sensing cycle; determine a target color based on the brightness parameters, wherein target compensation parameters of the sub-pixels having the target color can be acquired subsequently in the current sensing cycle; and compensation for the sub-pixels having the target color based on the target compensation parameters, instead of sensing the sub-pixel having each color in a preset sequence, can be performed in the current sensing cycle.

### CROSS-REFERENCE TO RELATED APPLICATION

The present application is a national stage of PCT application No. PCT/CN2023/119323, filed on Sep. 18, 2023, the entire contents of which are incorporated herein by reference.

### TECHNICAL FIELD

The present application relates to the field of display technologies, and in particular, to a control assembly, a method for controlling a display panel, and a display apparatus.

### BACKGROUND

A display apparatus is an apparatus used for implementing a display function, and may include a control assembly and a display panel. The control assembly may be configured to control and perform compensation on the display panel, thereby improve a display performance.

A control assembly is configured to: when a display panel displays, sense compensation parameters of sub-pixels having a color in a display region in a sensing cycle, and compensate for the sub-pixel having the color based on the compensation parameters; and sense compensation parameters of sub-pixels having another color in the display region in a preset sequence in a next sensing cycle, and compensate for the sub-pixel having the another color. Other cases can be deduced by analogy, so that compensation can be performed on a sub-pixel having each color.

However, flexibility of a compensation manner of the above control assembly is relatively low.

### SUMMARY

Embodiments of the present application provide a control assembly, a method for controlling a display panel, and a display apparatus. The technical solutions are as follows.

According to an aspect of the embodiments of the present application, a control assembly is provided. The control assembly is used for controlling a display panel, and is configured to:
acquire brightness parameters of sub-pixels of a plurality of colors in a display region of the display panel in the (n−1)^{th} sensing cycle, wherein brightness parameters of sub-pixels having any one of the plurality of colors are positively correlated with a sub-pixel parameter of the sub-pixels having the any one of the plurality of colors in the sensing cycle; the sub-pixel parameter includes at least one of the quantity of lightened sub-pixels and a gray-scale value about the lightened sub-pixels; the sensing cycle includes a duration of a plurality of frames during a display of the display panel; and n is an integer greater than or equal to 1;
determine a target color based on the brightness parameters of sub-pixels of the plurality of colors; and
acquire target compensation parameters of the sub-pixels having the target color in the n^{th} sensing cycle; and compensate for the sub-pixels having the target color based on the target compensation parameters.

In some embodiments, the control assembly is further configured to:
acquire first compensation parameters of sub-pixels having a first color of the plurality of colors in the (n−1)^{th} sensing cycle; and compensate for the sub-pixels having the first color based on the first compensation parameters; and
acquire second compensation parameters of sub-pixels having a second color of the plurality of colors in the (n+1)^{th} sensing cycle; and compensate for the sub-pixels having the second color based on the second compensation parameters.

In some embodiments, the display region includes x rows of sub-pixels; and the sensing cycle includes a duration of a*x frames, wherein a is an integer greater than or equal to 1.

In some embodiments, the control assembly is configured to:
acquire target compensation parameters of one row of sub-pixels having the target color in the display region in one frame of the n^{th} sensing cycle; and compensate for the one row of sub-pixels having the target color based on the target compensation parameters of the one row of sub-pixels.

In some embodiments, the display region includes a plurality of display sub-regions, wherein each of the display sub-regions includes a plurality of rows of sub-pixels; and
the control assembly is configured to:
acquire brightness parameters of sub-pixels of a plurality of colors in each of the plurality of display sub-regions in the (n−1)^{th} sensing cycle;
determine a display sub-region target color of each of the plurality of display sub-regions, wherein the display sub-region target color is a color of a sub-pixel having the greatest brightness parameter in each display sub-region; and
acquire compensation sub-parameters of sub-pixels having the display sub-region target color in each display sub-region in the n^{th} sensing cycle; and compensate for the sub-pixels having the display sub-region target color in each display sub-region based on the compensation sub-parameters.

In some embodiments, the display region includes a plurality of display sub-regions, wherein each of the display sub-regions includes a plurality of rows of sub-pixels; and
the control assembly is configured to:
acquire brightness parameters of sub-pixels of a plurality of colors in each of the plurality of display sub-regions in the (n−1)^{th} sensing cycle;
determine a first color display sub-region in the plurality of display sub-regions, wherein the first color display sub-region is a display sub-region that is in the plurality of display sub-regions and in which a sub-pixel having a first color has the greatest brightness parameter; and
acquire compensation sub-parameters of sub-pixels having the first color in the first color display sub-region in the n^{th} sensing cycle; and compensate for the sub-pixels having the first color in the first color display sub-region based on the compensation sub-parameters of the sub-pixels having the first color.

In some embodiments, the control assembly is further configured to:
determine a second color display sub-region in the plurality of display sub-regions, wherein the second color display sub-region is a display sub-region that is in the plurality of display sub-regions and in which a sub-pixel having a second color has the greatest brightness parameter; and
acquire compensation sub-parameters of sub-pixels having the second color in the second color display sub-region in the n^{th} sensing cycle; and compensate for the sub-pixels having the second color in the second color display sub-region based on the compensation sub-parameters of the sub-pixels having the second color.

In some embodiments, the plurality of display sub-regions includes at least one low-brightness display sub-region, wherein none of brightness parameters of sub-pixels of a plurality of colors in the low-brightness display sub-region is the greatest brightness parameter; and
the control assembly is further configured to:
acquire compensation sub-parameters of sub-pixels having a preset color in the at least one low-brightness display sub-region in the n^{th} sensing cycle; and compensate for the sub-pixels having the preset color based on the compensation sub-parameters of the sub-pixels having the preset color.

In some embodiments, the quantities of rows of sub-pixels included in the plurality of display sub-regions are the same.

In some embodiments, the target color is a color having the greatest brightness parameter in the plurality of colors.

In some embodiments, the control assembly is further configured to:
acquire first compensation parameters of sub-pixels having a first color of the plurality of colors in the (n−1)^{th} sensing cycle; and compensate for the sub-pixels having the first color based on the first compensation parameters; and
determine whether the brightness parameters of the plurality of colors include a brightness parameter of a sub-pixel having the target color that is greater than a brightness parameter threshold; and
in response to there being one brightness parameter of a sub-pixel having the target color that is greater than the brightness parameter threshold, acquire target compensation parameters of the sub-pixels having the target color in the n^{th} sensing cycle; and compensate for the sub-pixels having the target color based on the target compensation parameters.

In some embodiments, the display region includes s display sub-regions, wherein the quantities of rows of sub-pixels included in the display sub-regions are the same; and the control assembly is further configured to:
in response to brightness parameters of the s target colors are greater than the brightness parameter threshold being included, acquire target compensation parameters of sub-pixels of the s target colors in a first display sub-region of the s display sub-regions in the n^{th} sensing cycle; and compensate for the sub-pixels of the s target colors in the first display sub-region based on the target compensation parameters.

In some embodiments, the control assembly is further configured to:
acquire target compensation parameters of sub-pixels of the s target colors in a second display sub-region of the s display sub-regions in the (n+2)^{th} sensing cycle; and compensate for the sub-pixels of the s target colors in the second display sub-region based on the target compensation parameters.

In some embodiments, a brightness parameter of a sub-pixel having the first color of the plurality of colors in a specified region satisfies:

$$M = d * y ,$$

wherein
M is the brightness parameter of the sub-pixel having the first color in the specified region; d is the quantity of lightened sub-pixels having the first color in the specified region; and y is a sum of gray-scale values of the lightened sub-pixels having the first color in the specified region.

In some embodiments, the display region includes a plurality of display sub-regions, wherein a brightness parameter of a sub-pixel having the first color of the plurality of colors in the display sub-region satisfies:

$${M}^{′} = q * {d}^{′} * {y}^{′} ,$$

wherein
M′ is the brightness parameter of the sub-pixel having the first color in the display sub-region; d′ is the quantity of lightened sub-pixels having the first color in the display sub-region; y′ is a sum of gray-scale values of the lightened sub-pixels having the first color in the display sub-region; q is a weight parameter of the display sub-region; and the weight parameter is negatively correlated with the distance between the display sub-region and the center of the display region.

In some embodiments, the control assembly includes a timing controller.

According to another aspect of the embodiments of the present application, a method for controlling a display panel is provided. The method is used for controlling the display panel and includes:
acquiring brightness parameters of sub-pixels of a plurality of colors in a display region of the display panel in the (n−1)^{th} sensing cycle, wherein brightness parameters of sub-pixels having any one of the plurality of colors are positively correlated with a sub-pixel parameter of the sub-pixels having the any one of the plurality of colors in the sensing cycle; the sub-pixel parameter includes at least one of the quantity of lightened sub-pixels and a gray-scale value about the lightened sub-pixels; the sensing cycle includes a duration of a plurality of frames during a display of the display panel; and n is an integer greater than or equal to 1;
determining a target color based on the brightness parameters of the plurality of colors; and
acquiring target compensation parameters of the sub-pixels having the target color in the n^{th} sensing cycle; and compensating for the sub-pixels having the target color based on the target compensation parameters.

In some embodiments, the method further includes:
acquiring first compensation parameters of sub-pixels having a first color of the plurality of colors in the (n−1)^{th} sensing cycle; and compensating for the sub-pixel having the first color based on the first compensation parameter; and
acquiring second compensation parameters of sub-pixels having a second color of the plurality of colors in the (n+1)^{th} sensing cycle; and compensating for the sub-pixel having the second color based on the second compensation parameter.

According to still another aspect of the embodiments of the present application, a display apparatus is provided. The display apparatus includes a control assembly and a display panel, wherein the control assembly includes the above control assembly, and is connected to the display panel.

According to yet another aspect of the embodiments of the present application, a display apparatus is provided. The display apparatus includes a control assembly and a memory, wherein the memory stores at least one instruction, at least one program, a code set, or an instruction set; and the at least one instruction, the at least one program, the code set, or the instruction set is loaded and executed by the control assembly to implement the above control method.

According to still yet another aspect of the embodiments of the present application, a non-volatile computer storage medium is provided. The non-volatile computer storage medium stores at least one instruction, at least one program, a code set, or an instruction set, wherein the at least one instruction, the at least one program, the code set, or the instruction set is loaded and executed by a control assembly to implement the above control method.

### BRIEF DESCRIPTION OF DRAWINGS

For clearer descriptions of the technical solutions in the embodiments of the present application, the following briefly describes the accompanying drawings required for describing the embodiments. Apparently, the accompanying drawings in the following description show merely some embodiments of the present application, and other drawings may be derived by persons skilled in the art from these accompanying drawings without creative efforts.

FIG. 1 is a schematic structural diagram of a display apparatus according to an embodiment of the present application;

FIG. 2 is a schematic structural diagram of a compensation pixel circuit;

FIG. 3 is a schematic diagram of a compensation manner;

FIG. 4 is a schematic diagram of a control assembly of a display panel according to an embodiment of the present application;

FIG. 5 is a schematic diagram of a control flow of the control assembly shown in FIG. 4;

FIG. 6 is a schematic diagram of another control flow of the control assembly shown in FIG. 4;

FIG. 7 is a schematic diagram of a sensing cycle in the schematic diagram of the control flow shown in FIG. 6;

FIG. 8 is a schematic diagram of a display region according to an embodiment of the present application;

FIG. 9 is a schematic diagram of a sensing flow according to an embodiment of the present application;

FIG. 10 is a schematic diagram of another display region according to an embodiment of the present application;

FIG. 11 is a schematic diagram of another sensing flow according to an embodiment of the present application;

FIG. 12 is a schematic diagram of still another sensing flow according to an embodiment of the present application;

FIG. 13 is a flowchart of a method for controlling a display panel according to an embodiment of the present application; and

FIG. 14 is a structural block diagram of a control assembly according to an embodiment of the present application.

The above accompanying drawings have shown specific embodiments of the present application that are to be described in detail as follows. These accompanying drawings and text descriptions are not intended in any way to limit the scope of the concept of the present application, but to illustrate the conception of the present application for those skilled in the art with reference to specific embodiments.

### DETAILED DESCRIPTION

For clearer descriptions of the objectives, technical solutions, and advantages of the present application, embodiments of the present application are further described in detail hereinafter with reference to the accompanying drawings.

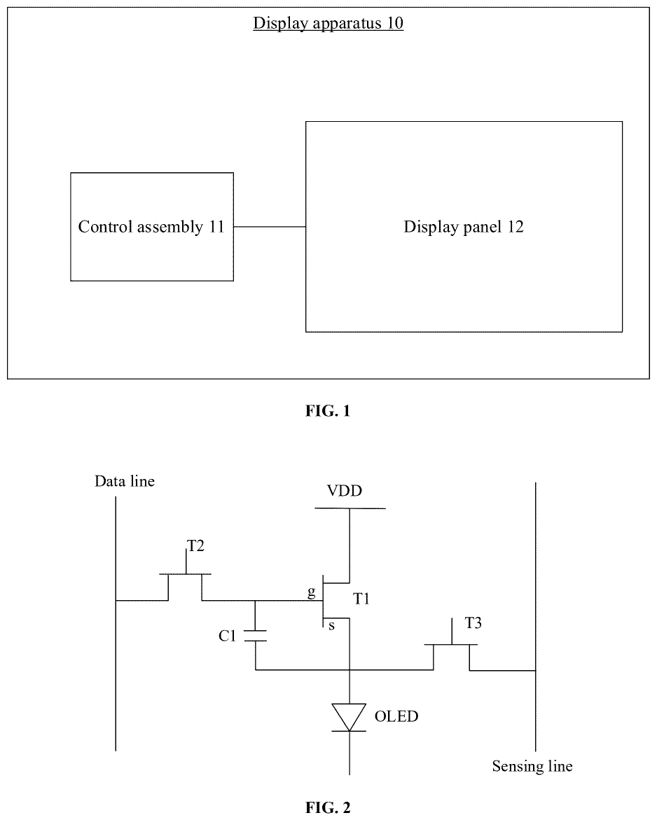

FIG. 1 is a schematic structural diagram of a display apparatus according to an embodiment of the present application. The display apparatus 10 may include a control assembly 11 and a display panel 12. The control assembly 11 is connected to the display panel 12 and can control the display panel 12.

Specifically, the control assembly 11 may send a signal to the display panel 12, thereby controlling the display panel 12 to display an image. The control assembly 11 may include a timing controller (TCON).

Because the display panel 12 may be affected by various factors in display processes of some electronic elements, electrical properties of these electronic elements are changed. Consequently, the display effect of the display panel 12 is relatively poor. Therefore, in some embodiments, a sub-pixel in the display panel may be sensed to acquire a compensation parameter (the compensation parameter may be referred to as a compensation value K); and the sub-pixel may be compensated for based on the compensation parameter. A change of K can represent a change of electronic mobility of a thin film transistor (Thin Film Transistor, TFT) in an organic light-emitting diode (Organic Light-Emitting Diode, OLED). Specifically, K is inversely proportional to the electronic mobility, and is affected by temperature, illumination, and the like.

For example, referring to FIG. 2 that is a schematic structural diagram of a compensation pixel circuit, the pixel circuit may include: a thin film transistor T1, a thin film transistor T2, a thin film transistor T3, a storage capacitor C1, an organic light-emitting diode, a data line, and a sensing line. A VDD may provide a working current for the OLED. The OLED is a current-type device. As the current flows into the OLED, heat is generated. Temperature of the display panel rises with an increase of light up time. A rise of the temperature makes voltage values detected at ends of the sensing line under the same voltage differ from each other. Compensation calculation formulas of the OLED display panel are:

$$Vgs = K \times \sqrt{L} + Vth ; and$$

$$K = 1 / ( a \times \sqrt{V s} ) ,$$

wherein Vgs is a gate-source voltage of T1; Vth is a threshold voltage of T1; Vs is a voltage detected at an end of the sensing line; and a is a constant. It may be learned from the above compensation calculation formulas that when the temperature rises, Vs becomes larger. Consequently, the compensation value K becomes smaller, and Vgs becomes smaller accordingly.

FIG. 3 is a schematic diagram of a compensation manner. Referring to FIG. 3, the control assembly may sense compensation parameters of one row of sub-pixels in each frame, and perform compensation based on the compensation parameters. In the solution shown in FIG. 3, the control assembly senses each color sequentially in preset order. Specifically, when sensing red sub-pixels, the control assembly may separately sense each row of red sub-pixels R in each frame, acquire corresponding compensation parameters, and perform compensation, until all rows of red sub-pixels R in a display region have been sensed completely. Then, the control assembly may start to sense green sub-pixels G. Other cases can be deduced by analogy, so that compensation can be performed on all sub-pixels of all colors in the display region in all frames. It should be noted that the control assembly may add a specific waveform in a non-display region in each frame, thereby sensing compensation parameters of one row of sub-pixels. In this way, normal display can be prevented from being affected by a compensation process.

In this manner, frequencies at which compensation is performed on sub-pixels having each color are the same. Time by which sub-pixels of one color in the display region are sensed=Duration of one frame×Quantity of rows of the sub-pixels in the display region. The duration of one frame may be equal to 1/frame rate. Time by which sub-pixels of all colors in the display region are sensed=n×Duration of one frame×Quantity of rows of the sub-pixels in the display region. n is the quantity of the colors of the sub-pixels. For example, when there are four colors (for example, red, green, blue, and white) of sub-pixels in the display region, the quantity of rows of the sub-pixels is 1080, and the frame rate is 60 Hertz, the time by which the sub-pixels of all the colors in the display region are sensed is: 4×( 1/60)×1080=72 seconds. An entire sensing cycle is relatively long. Frequencies at which the sub-pixels having each color are sensed are consistent with each other.

However, the applicant has found that in some display scenes, an amount having a color in an image displayed in the display region may be relatively large, and the color may be relatively bright. For example, in an image that displays a forest, a region in green may be larger than regions in other colors, brightness of the green region may be greater than brightness of the regions in the other colors. If the above manner is used, frequencies at which green sub-pixels are sensed and compensated for are consistent with frequencies at which sub-pixels in the other colors are sensed and compensated. It may be learned that flexibility of the compensation manner is relatively poor, and a compensation effect may be relatively poor.

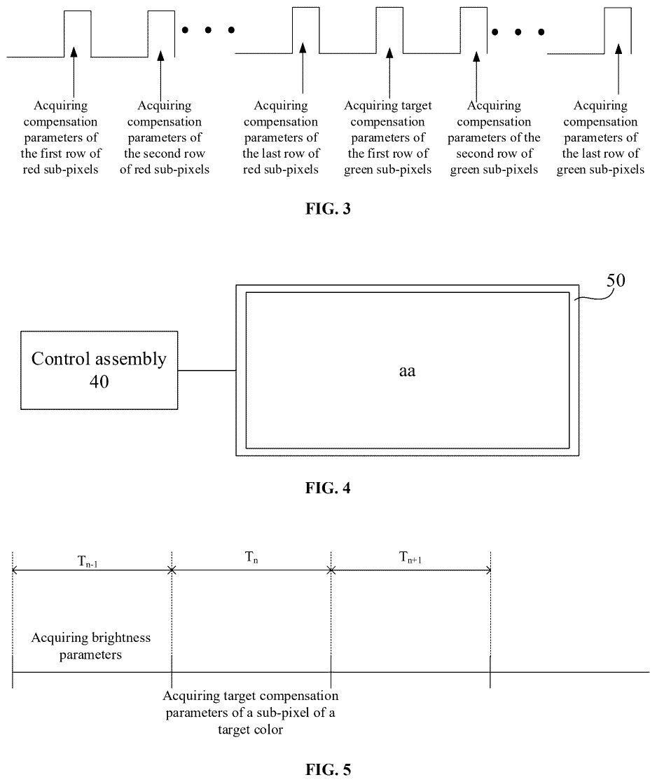

FIG. 4 is a schematic diagram of a control assembly of a display panel according to an embodiment of the present application. FIG. 5 is a schematic diagram of a control flow of the control assembly shown in FIG. 4. Referring to FIG. 4 and FIG. 5, the control assembly 40 may be used for controlling a display panel. The control assembly 40 is configured to:
acquire brightness parameters of sub-pixels of a plurality of colors in a display region aa of the display panel 50 in the (n−1)^{th} sensing cycle Tₙ₋₁, wherein brightness parameters of sub-pixels having any one of the plurality of colors are positively correlated with a sub-pixel parameter of the sub-pixels having the any one of the plurality of colors in the sensing cycle; the sub-pixel parameter includes at least one of the quantity of lightened sub-pixels and a gray-scale value about the lightened sub-pixels; the sensing cycle includes a duration of a plurality of frames when the display panel 50 displays; and n is an integer greater than or equal to 1;
determine a target color based on the brightness parameters of the plurality of colors; and
acquire target compensation parameters of the sub-pixels having the target color in the n^{th} sensing cycle Tₙ; and compensate for the sub-pixels having the target color based on the target compensation parameters.

For sensing and compensation manners in a subsequent sensing cycle, refer to those in the (n−1)^{th} sensing cycle Tₙ₋₁ shown in FIG. 5 and the (n+1)^{th} sensing cycle Tₙ₊₁. Details are not described in this embodiment of the present application.

In summary, the control assembly in this embodiment of the present application is configured to: acquire brightness parameters of sub-pixels of all colors in a previous sensing cycle; determine a target color based on the brightness parameters, wherein target compensation parameters of the sub-pixels having the target color can be acquired subsequently in the current sensing cycle; and compensate for the sub-pixels having the target color based on the target compensation parameters, instead of sensing the sub-pixel having each color in a preset sequence. In this way, compensation for a sub-pixel can be performed flexibly. This solves the problem that flexibility of a compensation manner in the related art for a control assembly is relatively low, thereby achieving an effect of improving the flexibility of the compensation manner.

It should be noted that sub-pixels of all colors that are included in the display region can emit rays of different colors when being lightened. Different sub-pixels are lightened for different images to be displayed. The above brightness parameter may be a parameter determined based on the lightened sub-pixels.

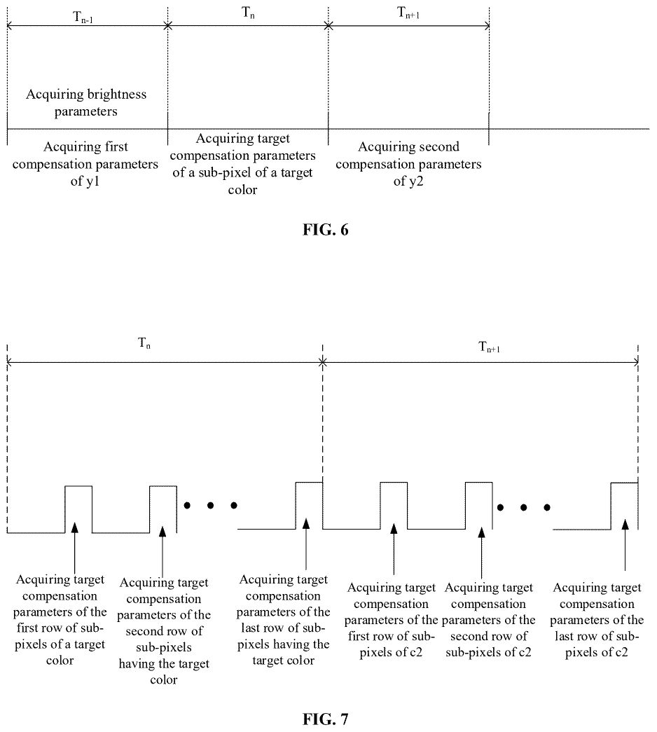

FIG. 6 is a schematic diagram of another control flow of the control assembly shown in FIG. 4. Referring to FIG. 4 and FIG. 6, the control assembly 40 is further configured to:
acquire first compensation parameters of a first color y1 of the plurality of colors in the (n−1)^{th} sensing cycle Tₙ₋₁; and compensate for a sub-pixel having the first color y1 based on the first compensation parameter; and
acquire second compensation parameters of a second color y2 of the plurality of colors in the (n+1)^{th} sensing cycle Tₙ₊₁; and compensate for a sub-pixel having the second color y2 based on the second compensation parameters.

The (n−1)^{th} sensing cycle Tₙ₋₁ and the (n+1)^{th} sensing cycle Tₙ₊₁ may be referred to as conventional sensing cycles. The n^{th} sensing cycle Tₙ between the (n−1)^{th} sensing cycle Tₙ₋₁ and the (n+1)^{th} sensing cycle Tₙ₊₁ may be referred to as a target sensing cycle. In the conventional sensing cycle, sub-pixels of all colors may be sensed and accordingly compensated for sequentially. In the target sensing cycle, a sub-pixel of a target color may be sensed, and accordingly compensated for based on a compensation parameter acquired via sensing. The target color is a color determined based on the brightness parameters of the sub-pixels of all the colors in the (n−1)^{th} sensing cycle Tₙ₋₁. The first color y1 is a color of any one of the sub-pixels of all the colors in the display region of the display panel. The second color y2 is a color that is different from the first color y1 and is of another one of the sub-pixels of all the colors in the display region of the display panel.

In this manner, the control assembly may sense and compensate for sub-pixels of all colors sequentially via conventional sensing cycles, and sense and compensate for a sub-pixel of a target color via a target sensing cycle between the conventional sensing cycles, to increase a compensation frequency of the sub-pixels having the target color and improve a compensation effect. Therefore, sub-pixels in the display panel are sensed and compensated for via a conventional sensing cycle and a target sensing cycle in turn. This can increase a compensation frequency of a sub-pixel of a target color on the premise that sub-pixels of all colors are compensated for. In addition, because the target color is determined based on brightness parameters, the compensation effect of the compensation manner can be improved.

For sensing and compensation manners in a subsequent sensing cycle, refer to those in the (n−1)^{th} sensing cycle Tₙ₋₁, the (n)^{th} sensing cycle Tₙ, and the (n+1)^{th} sensing cycle Tₙ₊₁ shown in FIG. 6. Details are not described in this embodiment of the present application.

In an example embodiment, the target color is a color having the greatest brightness parameter in the plurality of colors; or the target color is one or more colors that are of the plurality of colors and whose brightness parameters are greater than a brightness parameter threshold. In other words, the control assembly may determine, as the target color, one or more colors that are of the plurality of colors of the display panel and have relatively large brightness. A sub-pixel having a color having a relatively large brightness is relatively visible to human eyes. The control assembly according to this embodiment of the present application increases frequencies by which a sub-pixel of a target color having relatively large brightness is sensed and compensated for, so that the display effect of the sub-pixels having the target color having the relatively large brightness can be improved. In addition, because this portion of sub-pixels are relatively visible to human eyes, the display effect of the sub-pixels in user's eyes and user's experience of viewing the sub-pixels can be improved.

It should be noted that the control assembly may alternatively determine a target color in various manners. For example, the control assembly may determine, as the target color, any one or more of colors that do not have the smallest brightness parameter.

In this embodiment of the present application, brightness parameters of sub-pixels having any one of the plurality of colors are positively correlated with a sub-pixel parameter of the sub-pixels having the any one of the plurality of colors in the sensing cycle; and the sub-pixel parameter may include at least one of the quantity of lightened sub-pixels and a gray-scale value about the lightened sub-pixels. In other words, for sub-pixels of one color, a larger quantity of lightened sub-pixels having the color leads to a greater brightness parameter; and a larger gray-scale value of the lightened sub-pixels having the color also leads to a greater brightness parameter.

In some embodiments, a brightness parameter of a part or all of the display region may be determined. For this purpose, a brightness parameter of a sub-pixel having the first color of the plurality of colors in a specified region may satisfy:

$$M = d * y ,$$

wherein
M is the brightness parameter of the sub-pixel having the first color in the specified region; d is the quantity of lightened sub-pixels having the first color in the specified region; and y is a sum of gray-scale values of lightened sub-pixels having the first color in the specified region. The specified region may be a part or all of the display region of the display panel.

For example, the specified region is all of the display region; the first color is red; the quantity of lightened red sub-pixels in the display region is 100; and a sum of gray-scale values of the 100 red sub-pixels is 1000. In this case, the brightness parameter M of the specified region is 100*1000=100000.

In this brightness parameter determining manner, influences of the gray-scale value and the quantity on the brightness parameter can be extended, helping distinguish between brightness parameters of sub-pixels of different colors.

When the control assembly in this embodiment of the present application performs sensing, a sensing cycle may be related to the quantity of rows of sub-pixels in the display region of the display panel. In an example embodiment, the display region includes x rows of sub-pixels. In this case, the sensing cycle includes a duration of a*x frames, wherein a is an integer greater than or equal to 1.

In other words, the duration of the sensing cycle may be an integral multiple of a product of the quantity of rows of sub-pixels in the display region and duration of one frame, to ensure that sub-pixels of at least one color can be sensed completely in one sensing cycle.

When a is 1, in one sensing cycle, the control assembly may acquire compensation parameters of sub-pixels of one color in all rows in the display region. When a is 2, in one sensing cycle, the control assembly may acquire compensation parameters of sub-pixels of two colors in all rows in the display region.

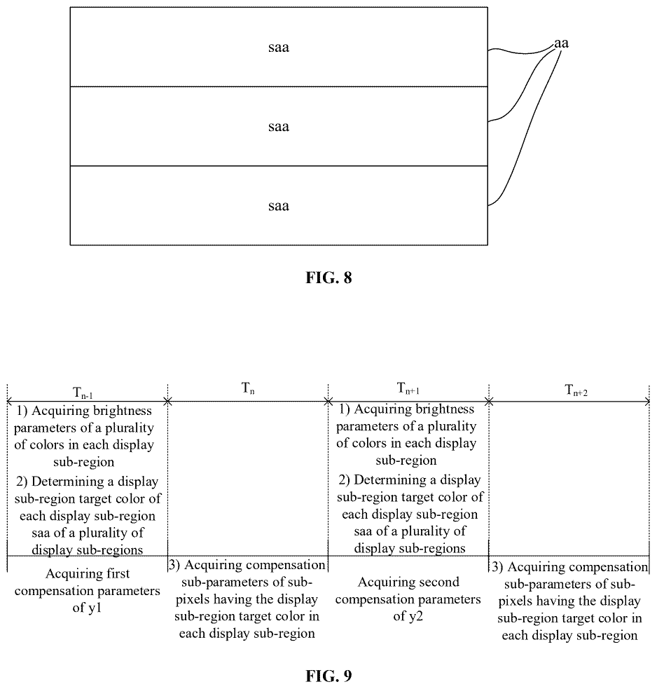

In an example embodiment, FIG. 7 is a schematic diagram of a sensing cycle in the schematic diagram of the control flow shown in FIG. 6. Referring to FIG. 4 and FIG. 7, the control assembly 40 may be configured to:
acquire target compensation parameters of one row of sub-pixels having the target color in the display region in one frame of the n^{th} sensing cycle Tₙ; and compensate for the one row of sub-pixels having the target color based on the target compensation parameters of the one row of sub-pixels.

In FIG. 7, a high-level region may represent a non-display region in one frame when display signal transmission is performed in the duration (but an actual level of a signal is not limited); and a low-level region may represent a display region in one frame when display signal transmission is performed in the duration (but an actual level of a signal is not limited). It may be learned that the control assembly 40 may acquire compensation parameters of one row of sub-pixels in a non-display region in each frame.

It should be noted that the display region of the display panel may include a plurality of rows of pixels. Each row of pixels may include a plurality of pixels. Each pixel may include a plurality of sub-pixels. The quantity of rows of the sub-pixels is equal to the quantity of rows of the pixels. For example, for a display panel whose resolution is 1920×1080, the display region may include 1080 rows of pixels; one row of pixels may include 1920 pixels; each pixel may include three or four sub-pixels; and the quantity of rows of the sub-pixels is also 1080.

In the above embodiment, the control assembly may sense and compensate for the display region as an entire region. However, in an example embodiment, the display region of the display panel may include a plurality of display sub-regions. Each of the display sub-regions includes a plurality of rows of sub-pixels. The control assembly may sense and compensate for the plurality of display sub-regions.

FIG. 8 is a schematic diagram of a display region according to an embodiment of the present application. FIG. 9 is a schematic diagram of a sensing flow according to an embodiment of the present application. Referring to FIG. 8 and FIG. 9, in an example embodiment, the display region aa includes a plurality of display sub-regions saa. The control assembly is configured to:

1) acquire brightness parameters of a plurality of colors in each of the plurality of display sub-regions in the (n−1)^{th} sensing cycle Tₙ₋₁.

For a computation manner of a brightness parameter of any one of the plurality of display sub-regions, refer to the computation manner of the brightness parameter of the specified region according to the above embodiment. The control assembly may use one display sub-region as one specified region, and computes a brightness parameter of the display sub-region. In other words, a brightness parameter of a sub-pixel having the first color of the plurality of colors in the specified region may satisfy:

$$M = d * y ,$$

wherein
M is the brightness parameter of the sub-pixel having the first color in the display sub-region; d is the quantity of lightened sub-pixels having the first color in the display sub-region; and y is a sum of gray-scale values of the lightened sub-pixels having the first color in the specified region.

Certainly, the brightness parameter of the display sub-region may be determined in another computation manner. For example, the brightness parameter of the sub-pixel having the first color of the plurality of colors in the display sub-region may satisfy:

$${M}^{′} = q * {d}^{′} * {y}^{′} ,$$

wherein
M′ is the brightness parameter of the sub-pixel having the first color in the display sub-region; d′ is the quantity of lightened sub-pixels having the first color in the display sub-region; the display sub-region may be a part of the display region of the display panel; y′ is a sum of gray-scale values of lightened sub-pixels having the first color in the display sub-region; q is a weight parameter of the display sub-region; and the weight parameter may be negatively correlated with the distance between the display sub-region and the center of the display region of the display panel. In other words, a greater value of the distance between the display sub-region and the center of the display region leads to a smaller value of the weight parameter q; and a smaller value of the distance between the display sub-region and the center of the display region leads to a greater value of the weight parameter q. This is because a user pays more attention to a region closer to the center of the display region than an edge region farther from the center. Therefore, the weight parameter of the region closer to the center may be improved to increase the compensation frequency of this region.

For example, as shown in FIG. 8, if the distance between a first display sub-region aa1 and the center z of the display region is greater than the distance between a second display sub-region aa2 and the center z of the display region, the weight parameter of the second display sub-region aa2 may be greater than the weight parameter of the first display sub-region aa1.

In addition, the control assembly may further acquire first compensation parameters of a first color y1 in the (n−1)^{th} sensing cycle Tₙ₋₁; and compensate for the sub-pixels having the first color based on the first compensation parameters; and

2) determine a display sub-region target color of each display sub-region saa of a plurality of display sub-regions, wherein the display sub-region target color is a color having the greatest brightness parameter in each display sub-region saa.

In this step, the control assembly may determine the display sub-region target color of each display sub-region saa based on brightness parameters of all colors in each display sub-region saa that are determined in the above manner, wherein the display sub-region target color may be a color having the greatest brightness parameter in each display sub-region saa. For example, in the first display sub-region, the brightness parameter of a red sub-pixel is 10000; the brightness parameter of a green sub-pixel is 12000; the brightness parameter of a blue sub-pixel is 15000; the brightness parameter of a white sub-pixel is 20000; and the control assembly may determine white as the display sub-region target color of the first display sub-region.

The control assembly may perform this step after acquiring the brightness parameters of the plurality of colors in each of the plurality of display sub-regions in the (n−1)^{th} sensing cycle Tₙ₋₁.

3) Compensation sub-parameters of sub-pixels having the display sub-region target color in each display sub-region is acquired in the n^{th} sensing cycle; and the sub-pixel of the display sub-region target color in each display sub-region is compensated for based on the compensation sub-parameter.

After determining the display sub-region target color of each display sub-region saa, the control assembly may acquire compensation sub-parameters of sub-pixels having the display sub-region target color in each display sub-region saa in the n^{th} sensing cycle, and perform corresponding compensation. Because the display sub-regions may display different container, each display sub-region can be sensed and compensated for independently in this manner. This can further improve the compensation effect of the display panel.

It should be noted that in one sensing cycle, the control assembly may sense and compensate for a sub-pixel of one color in the entire display region for at least one time; and the plurality of display sub-regions may be a plurality of regions formed by dividing the display region. Therefore, the control assembly may sense and compensate for the plurality of display sub-regions separately in one sensing cycle.

In addition, in a subsequent sensing cycle, the control assembly may perform operations with reference to those in the (n−1)^{th} sensing cycle and the n^{th} sensing cycle. Details are not described in this embodiment of the present application.

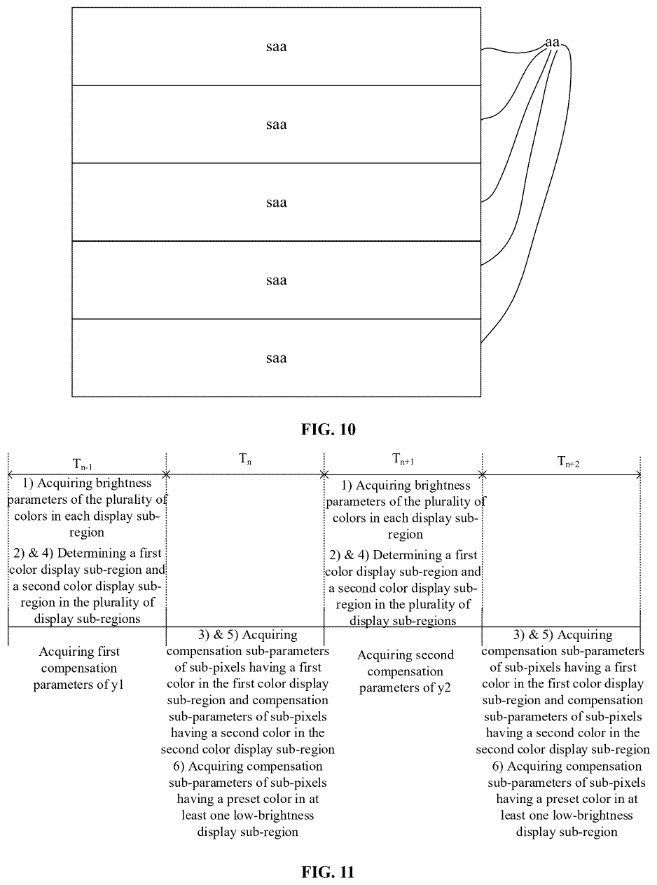

The control assembly in this embodiment of the present application may sense and compensate for the plurality of display sub-regions in another manner. For example, FIG. 10 is a schematic diagram of another display region according to an embodiment of the present application; and FIG. 11 is a schematic diagram of another sensing flow according to an embodiment of the present application. Referring to FIG. 10 and FIG. 11, in an example embodiment, the display region aa includes a plurality of display sub-regions saa; and each of the display sub-regions saa includes a plurality of rows of sub-pixels.

The control assembly is configured to:

1) acquire brightness parameters of a plurality of colors in each of the plurality of display sub-regions in the (n−1)^{th} sensing cycle Tₙ₋₁.

Quantities of rows of sub-pixels included in the plurality of display sub-regions may be the same. In this way, complexity levels of manners in which the control assembly senses and compensates for the plurality of display sub-regions can be lowered. For example, if the display region includes 1000 rows of sub-pixels in total, and there are five display sub-regions, each of the five display sub-regions may include 200 rows of sub-pixels.

Certainly, the quantities of the rows of sub-pixels included in the plurality of display sub-regions may alternatively be different. This is not limited in this embodiment of the present application.

For a manner in which the control assembly acquires a brightness parameter, reference may be made to the above embodiment. Details are not described in this embodiment of the present application.

2) A first color display sub-region in the plurality of display sub-regions is determined.

The control assembly may determine the first color display sub-region in the plurality of display sub-regions after determining the brightness parameters having each color in each display sub-region. The first color display sub-region is a display sub-region that is in the plurality of display sub-regions and in which a sub-pixel having a first color has the greatest brightness parameter. This step may be performed in the (n−1)^{th} sensing cycle Tₙ₋₁ after the control assembly acquires the brightness parameters of the plurality of colors in each display sub-region.

This determining process may specifically include the following steps.

2.1 The control assembly determines the brightness parameter of the sub-pixel having each color in all the display sub-regions.

The control assembly may determine the brightness parameter of the sub-pixel having each color in each display sub-region, so that one display sub-region may have brightness parameters of a plurality of colors.

For example, if the display region includes sub-pixels of four colors: red, green, blue, and white, the control assembly may determine brightness parameters corresponding to the four colors in each display sub-region.

In a specific example, the display region may include a first display sub-region, a second display sub-region, a third display sub-region, a fourth display sub-region, and a fifth display sub-region. For brightness parameters of sub-pixels having each color in the display sub-regions, refer to Table 1:

TABLE 1

| | First | Second | Third | Fourth | Fifth |
|---|---|---|---|---|---|
| | display | display | display | display | display |
| | sub-region | sub-region | sub-region | sub-region | sub-region |
| Red | 10000 | 12000 | 13000 | 14000 | 15000 |
| sub-pixel | | | | | |
| Green | 20000 | 21000 | 22000 | 24000 | 22000 |
| sub-pixel | | | | | |
| Blue | 41000 | 42000 | 45000 | 44000 | 43000 |
| sub-pixel | | | | | |
| White | 64000 | 61000 | 62000 | 63000 | 60000 |
| sub-pixel | | | | | |

Data recorded in Table 1 are brightness parameters. The control assembly may determine a display sub-region corresponding to the greatest brightness parameter having each color based on some brightness parameters shown in Table 1. For example, the greatest brightness parameter of red sub-pixels is 15000, so that a display sub-region corresponding to the greatest brightness parameter of the red sub-pixels is the fifth display sub-region; the greatest brightness parameter of green sub-pixels is 24000, so that a display sub-region corresponding to the greatest brightness parameter of the green sub-pixels is the fourth display sub-region; and a display sub-region having the greatest brightness parameter of sub-pixels having each color may be determined by analogy.

2.2 The control assembly determines the first color display sub-region based on the brightness parameter of the sub-pixel having each color in the display sub-regions.

The control assembly may determine, as the first color display sub-region, a display sub-region in which a brightness parameter having the first color is greatest. The parameters shown in Table 1 are used as examples. If the first color is red, the first color display sub-region is a red display sub-region, and the control assembly may determine, as the red display sub-region, the fifth display sub-region that has the greatest brightness parameter of the red sub-pixels.

3) Compensation sub-parameters of sub-pixels having the first color in the first color display sub-region is acquired in the n^{th} sensing cycle Tₙ; and the sub-pixel having the first color in the first color display sub-region is compensated for based on the compensation sub-parameter of the sub-pixel having the first color.

After determining the first color display sub-region, the control assembly may acquire compensation sub-parameters of sub-pixels having the first color in the first color display sub-region in the n^{th} sensing cycle, and compensate for the sub-pixels having the first color in the first color display sub-region based on the compensation sub-parameters of the sub-pixels having the first color. The compensation sub-parameter is similar to the above compensation parameter. The first color display sub-region includes several rows of sub-pixels. The control assembly may acquire compensation parameters of the several rows of sub-pixels in duration of several frames, and perform corresponding compensation.

In this manner, each color in the display region of the display panel may be a target color. For each color, the control assembly may select one or more display sub-regions from the plurality of display sub-regions for sensing and compensation.

4) A second color display sub-region in the plurality of display sub-regions is determined.

The control assembly may determine the second color display sub-region in the plurality of display sub-regions with reference to the above step of determining the first color display sub-region. The second color display sub-region is a display sub-region that is in the plurality of display sub-regions and in which a sub-pixel having a second color has the greatest brightness parameter. For example, data shown in Table 1 are used as examples. The second color may be blue. In this case, the second color display sub-region is a blue display sub-region. The control assembly may determine, as the blue display sub-region, the third display sub-region that has the greatest brightness parameter of the blue sub-pixels.

5) Compensation sub-parameters of sub-pixels having the second color in the second color display sub-region is acquired in the n^{th} sensing cycle Tₙ; and the sub-pixel having the first color in the second color display sub-region is compensated for based on the compensation sub-parameter of the sub-pixel having the second color.

After determining the second color display sub-region, the control assembly may acquire compensation sub-parameters of sub-pixels having the second color in the second color display sub-region in the n^{th} sensing cycle, and compensate for the sub-pixel having the second color in the second color display sub-region based on the compensation sub-parameter of the sub-pixel having the second color. The compensation sub-parameter is similar to the above compensation parameter. The second color display sub-region includes several rows of sub-pixels. The control assembly may acquire compensation parameters of the several rows of sub-pixels in duration of several frames, and perform corresponding compensation.

In an example embodiment, because brightness parameters of sub-pixels of a plurality of colors in one display sub-region may be the greatest brightness parameters of the sub-pixels of the plurality of colors, the second color display sub-region and the first color display sub-region may be a same display sub-region (certainly, the second color display sub-region and the first color display sub-region may alternatively be different display sub-regions). For example, refer to Table 2.

TABLE 2

| | First | Second | Third | Fourth | Fifth |
|---|---|---|---|---|---|
| | display | display | display | display | display |
| | sub-region | sub-region | sub-region | sub-region | sub-region |
| Red | 10000 | 12000 | 13000 | 14000 | 15000 |
| sub-pixel | | | | | |
| Green | 20000 | 21000 | 22000 | 24000 | 22000 |
| sub-pixel | | | | | |
| Blue | 41000 | 42000 | 45000 | 44000 | 43000 |
| sub-pixel | | | | | |
| White | 61000 | 61000 | 68000 | 63000 | 60000 |
| sub-pixel | | | | | |

Table 2 is a table of brightness parameters of another type of display sub-regions according to an embodiment of the present application. It can be learned from Table 2 that the brightness parameter of the blue sub-pixel in the third display sub-region is the greatest brightness parameter of the blue sub-pixels in all the display sub-regions; and the brightness parameter of the white sub-pixel in the third display sub-region is the greatest brightness parameter of the white sub-pixels in all the display sub-regions. Therefore, the third display sub-region may be both a blue display sub-region and a white display sub-region. In this case, the control assembly may separately acquire compensation sub-parameters of the blue sub-pixels in the third display sub-region and compensation sub-parameters of the white sub-pixels in the third display sub-region in the n^{th} sensing cycle, and compensate for the blue sub-pixel and the white sub-pixel in the third display sub-region.

Certainly, one display sub-region may alternatively include more color display sub-regions. In this case, the control assembly may perform sensing and compensation in the above manner. Details are not described in this embodiment of the present application.

It should be noted that when the quantity of display sub-regions is greater than the quantity of colors of sub-pixels in the display region of the display panel, there may be one or more display sub-regions in which none of brightness parameters of sub-pixels of all colors is the greatest brightness parameter. In this case, the control assembly may further perform subsequent steps.

6) Compensation sub-parameters of sub-pixels having a preset color in at least one low-brightness display sub-region are acquired in the n^{th} sensing cycle; and the sub-pixel having the preset color is compensated for based on the compensation sub-parameter of the sub-pixel having the preset color.

In an example embodiment, the plurality of display sub-regions in the display region of the display panel includes at least one low-brightness display sub-region, wherein none of brightness parameters of sub-pixels of a plurality of colors in the low-brightness display sub-region is the greatest brightness parameter. In this case, the control assembly may acquire the compensation sub-parameter of the sub-pixel having the preset color in the at least one low-brightness display sub-region in the n^{th} sensing cycle; and compensate for the sub-pixels having the preset color based on the compensation sub-parameters of the sub-pixels having the preset color.

For example, data shown in Table 2 are used as examples. None of the brightness parameter of the red sub-pixel, the brightness parameter of the blue sub-pixel, the brightness parameter of the green sub-pixel, and the brightness parameter of the white sub-pixel in the second display sub-region is the greatest brightness parameter, so that the second display sub-region is the low-brightness display sub-region. The control assembly may sense and compensate for, based on a preset color sequence, a sub-pixel having a preset color in the second display sub-region that is used as the low-brightness display sub-region.

Certainly, in some cases, there may be no low-brightness display sub-region in the display region. For example, when the quantity of display sub-regions is less than or equal to the quantity of colors of sub-pixels in the display region, there may be no low-brightness display sub-region in the display region. This is not limited in this embodiment of the present application.

For a control manner in a subsequent sensing cycle, refer to those in the (n−1)^{th} sensing cycle Tₙ₋₁ and the n^{th} sensing cycle Tₙ. Details are not described in this embodiment of the present application.

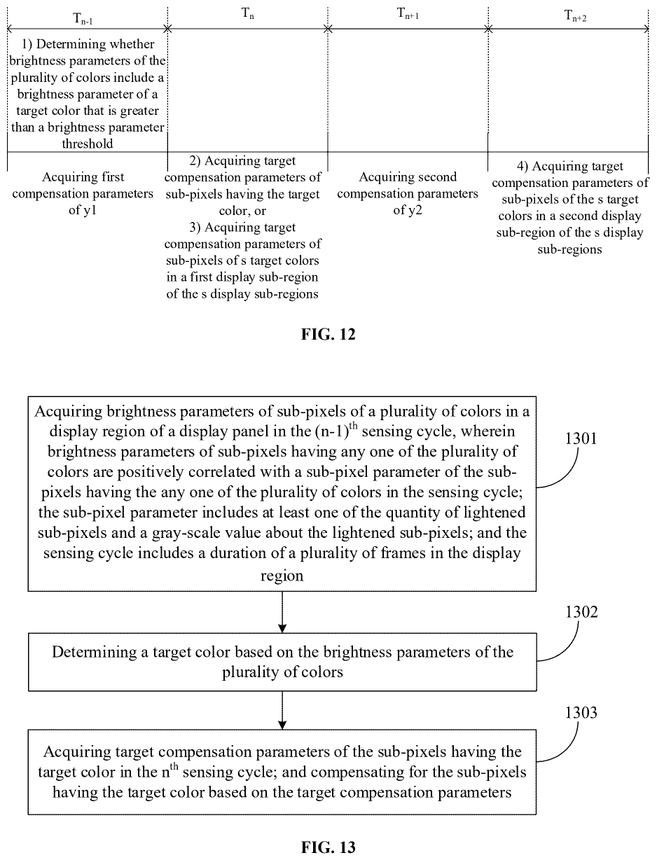

The control assembly in this embodiment of the present application may alternatively determine the target color in some other manners. FIG. 12 is a schematic diagram of still another sensing flow according to an embodiment of the present application. Referring to FIG. 12, the control assembly is further configured to:

1) determine whether brightness parameters of a plurality of colors include a brightness parameter of a target color that is greater than a brightness parameter threshold.

After acquiring the brightness parameters of the sub-pixels of the plurality of colors in the display region of the display panel in the (n−1)^{th} sensing cycle, the control assembly may determine whether the brightness parameters of the plurality of colors include the brightness parameter of a sub-pixel having the target color that is greater than the brightness parameter threshold. In other words, the control assembly may determine, as the target color, a color of a sub-pixel that is in the sub-pixels of the plurality of colors and whose brightness parameter is greater than the brightness parameter threshold.

For example, in the display region, if the brightness parameter of a red sub-pixel is 10000, the brightness parameter of a green sub-pixel is 20000, the brightness parameter of a blue sub-pixel is 30000, the brightness parameter of a white sub-pixel is 40000, and the brightness parameter threshold is 25000, the control assembly may determine, as target colors, blue corresponding to a blue sub-pixel whose brightness parameter is greater than 25000 and white corresponding to a white sub-pixel whose brightness parameter is greater than 25000. Certainly, the brightness parameters of the sub-pixels of all the colors may be less than or equal to the brightness parameter threshold. In this case, there is no target color. This is not limited in this embodiment of the present application.

In addition, the control assembly may acquire first compensation parameters of a first color of the plurality of colors in the (n−1)^{th} sensing cycle; and compensate for the sub-pixels having the first color based on the first compensation parameters; and

2) in response to there being one brightness parameter of a sub-pixel having the target color that is greater than the brightness parameter threshold, acquire target compensation parameters of one sub-pixel having the target color in the n^{th} sensing cycle Tₙ; and compensate for the sub-pixels having the target color based on the target compensation parameters.

When there is only one color whose sub-pixel has a brightness parameter greater than the brightness parameter threshold, the control assembly may acquire target compensation parameters of sub-pixels of the one target color in the n^{th} sensing cycle; and compensate for the sub-pixel of the one target color based on the target compensation parameters; and

3) in response to brightness parameters of the s target colors are greater than the brightness parameter threshold being included, acquire target compensation parameters of sub-pixels of the s target colors in a first display sub-region of s display sub-regions in the n^{th} sensing cycle Tₙ; and compensate for the sub-pixels of the s target colors in the first display sub-region based on the target compensation parameters.

Referring to FIG. 12 and FIG. 10, when there are s colors whose sub-pixels have brightness parameters greater than the brightness parameter threshold, the display region may include s display sub-regions, and the quantities of rows of sub-pixels included in the display sub-regions are the same. Correspondingly, the control assembly may acquire target compensation parameters of sub-pixels of the s target colors in a first display sub-region of the s display sub-regions in the n^{th} sensing cycle; and compensate for the sub-pixels of the s target colors in the first display sub-region based on the target compensation parameters. To compensate for sub-pixels of s colors, the control assembly may sense and compensate for 1/s of the display sub-regions of the display region in one sensing cycle.

In addition, the control assembly acquires second compensation parameters of a second color of the plurality of colors in the (n+1)^{th} sensing cycle; and compensates for the sub-pixel having the second color based on the second compensation parameter. Therefore, in the (n+1)^{th} sensing cycle, the control assembly may sense and compensate for a sub-pixel of one color in each sensing cycle sequentially in a preset sequence.

4) Target compensation parameters of sub-pixels of the s target colors in a second display sub-region of the s display sub-regions are acquired in the (n+2)^{th} sensing cycle Tₙ₊₂; and the sub-pixels of the s target colors in the second display sub-region are compensated for based on the target compensation parameters.

In other words, the control assembly may sense and compensate for sub-pixels of the s target colors in the s display sub-regions in the s sensing cycles respectively.

The sensing cycle in which target compensation parameters of sub-pixels of s target colors in one display sub-region of s display sub-regions are acquired and in which the sub-pixels of the s target colors in the one display sub-region are compensated for based on the target compensation parameters may be referred to as a target sensing cycle. A sensing cycle in which a sub-pixel of one color in each sensing cycle is sensed and compensated for sequentially in a preset sequence may be referred to as a conventional sensing cycle. There may be at least one conventional sensing cycle between any two adjacent target sensing cycles.

In addition, when there is no color whose sub-pixel has a brightness parameter greater than the brightness parameter threshold, the control assembly may continue to sense and compensate for a sub-pixel of one color in each sensing cycle sequentially in the preset sequence.

In summary, the control assembly in this embodiment of the present application is configured to: acquire brightness parameters of sub-pixels of all colors in a previous sensing cycle; determine a target color based on the brightness parameters, wherein target compensation parameters of the sub-pixels having the target color can be acquired subsequently in the current sensing cycle; and compensate for the sub-pixels having the target color based on the target compensation parameters, instead of sensing the sub-pixel having each color in a preset sequence. In this way, compensation for a sub-pixel can be performed flexibly. This solves the problem that flexibility of a compensation manner in the related art for a control assembly is relatively low, thereby achieving an effect of improving the flexibility of the compensation manner.

FIG. 13 is a flowchart of a method for controlling a display panel according to an embodiment of the present application. The method may be applied to the control assembly according to the above embodiments, to control a display panel. The method may include the following steps:

In step 1301, brightness parameters of sub-pixels of a plurality of colors in a display region of the display panel are acquired in the (n−1)^{th} sensing cycle, wherein brightness parameters of sub-pixels having any one of the plurality of colors are positively correlated with a sub-pixel parameter of the sub-pixels having the any one of the plurality of colors in the sensing cycle; the sub-pixel parameter includes at least one of the quantity of lightened sub-pixels and a gray-scale value about the lightened sub-pixels; and the sensing cycle includes a duration of a plurality of frames in the display region.

In step 1302, a target color is determined based on the brightness parameters of the plurality of colors.

In step 1303, target compensation parameters of the sub-pixels having the target color is acquired in the n^{th} sensing cycle; and the sub-pixels having the target color is compensated for based on the target compensation parameters.

In summary, the method for controlling a display panel in this embodiment of the present application includes: acquiring brightness parameters of sub-pixels of all colors in a previous sensing cycle; determining a target color based on the brightness parameters, wherein target compensation parameters of the sub-pixels having the target color can be acquired subsequently in the current sensing cycle; and compensating for the sub-pixels having the target color based on the target compensation parameters, instead of sensing the sub-pixel having each color in a preset sequence. In this way, compensation for a sub-pixel can be performed flexibly. This solves the problem that flexibility of a compensation manner in the related art for a control assembly is relatively low, thereby achieving an effect of improving the flexibility of the compensation manner.

In some embodiments, the above method further includes:

1) acquiring first compensation parameters of a first color of the plurality of colors in the (n−1)^{th} sensing cycle; and compensating for the sub-pixel having the first color based on the first compensation parameter.

This step and the above step 1301 may be both performed in the (n−1)^{th} sensing cycle. For specific content of this step, refer to the above embodiments of the control assembly. Details are not described in this embodiment of the present application.

2) Second compensation parameters of a second color of the plurality of colors are acquired in the (n+1)^{th} sensing cycle; and the sub-pixel having the second color is compensated for based on the second compensation parameter.

This step may be performed after the above step 1303. For specific content of this step, refer to the above embodiments of the control assembly. Details are not described in this embodiment of the present application.

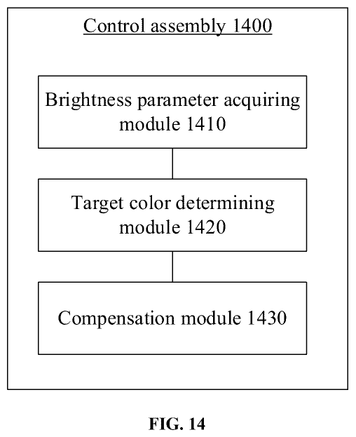

FIG. 14 is a structural block diagram of a control assembly according to an embodiment of the present application. The control assembly 1400 includes:
a brightness parameter acquiring module 1410 configured to acquire brightness parameters of sub-pixels of a plurality of colors in a display region of a display panel in the (n−1)^{th} sensing cycle, wherein brightness parameters of sub-pixels having any one of the plurality of colors are positively correlated with a sub-pixel parameter of the sub-pixels having the any one of the plurality of colors in the sensing cycle; the sub-pixel parameter includes at least one of the quantity of lightened sub-pixels and a gray-scale value about the lightened sub-pixels; and the sensing cycle includes a duration of a plurality of frames in the display region;
a target color determining module 1420 configured to determine a target color based on the brightness parameters of the plurality of colors; and
a compensation module 1430 configured to acquire target compensation parameters of the sub-pixels having the target color in the n^{th} sensing cycle; and compensate for the sub-pixels having the target color based on the target compensation parameters.

In summary, the control assembly in this embodiment of the present application is configured to: acquire brightness parameters of sub-pixels of all colors in a previous sensing cycle; determine a target color based on the brightness parameters, wherein target compensation parameters of the sub-pixels having the target color can be acquired subsequently in the current sensing cycle; and compensate for the sub-pixels having the target color based on the target compensation parameters, instead of sensing the sub-pixel having each color in a preset sequence. In this way, compensation for a sub-pixel can be performed flexibly. This solves the problem that flexibility of a compensation manner in the related art for a control assembly is relatively low, thereby achieving an effect of improving the flexibility of the compensation manner.

In addition, an embodiment of the present application further provides a display apparatus. The display apparatus includes a control assembly and a memory, wherein the memory stores at least one instruction, at least one program, a code set, or an instruction set; and the at least one instruction, the at least one program, the code set, or the instruction set is loaded and executed by the control assembly to implement the above control method.

An embodiment of the present application further provides a non-volatile computer storage medium. The non-volatile computer storage medium stores at least one instruction, at least one program, a code set, or an instruction set, wherein the at least one instruction, the at least one program, the code set, or the instruction set is loaded and executed by a control assembly to implement the above control method.

In the present application, the term “at least one of A and B” merely describes an association relationship between associated objects, and indicates three relationships. For example, “at least one of A and B” may indicate three cases: only A exists, both A and B exist, and only B exists. Similarly, “at least one of A, B, and C” indicates seven relationships: only A exists, only B exists, only C exists, both A and B exist, both A and C exist, both C and B exist, and all of A, B, and C exist. Similarly, “at least one of A, B, C, and D” indicates fifteen relationships: only A exists, only B exists, only C exists, only D exists, both A and B exist, both A and C exist, both A and D exist, both C and B exist, both D and B exist, both C and D exist, all of A, B, and C exist, all of A, B, and D exist, all of A, C, and D exist, all of B, C, and D exist, and all of A, B, C, and D exist.

In the present application, the terms “first”, “second”, “third”, “fourth”, “fifth”, and the like are only used for descriptive purposes and cannot be understood as indicating or implying relative importance. Unless otherwise defined, the term “a plurality of” refers to two or more.

In the embodiments of the present application, it should be understood that the disclosed apparatus and method may be implemented in other manners. For example, the above apparatus embodiments are merely examples. For example, division of the units is merely logical function division. In actual implementation, there may be another division manner. For example, a plurality of units or assemblies may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or another form.

The units described as separate components may be or may not be physically separate, and components displayed as units may be or may not be physical units, that is, may be located in one place or distributed on a plurality of network units. Some or all of the units may be selected according to actual needs to achieve the objectives of the solutions of the embodiments.

A person of ordinary skill in the art may understand that all or some of the steps for implementing the above embodiments may be completed by hardware, or may be completed by instructing related hardware by using a program. The program may be stored in a computer-readable storage medium. The above-mentioned storage medium may be a read-only memory, a magnetic disk, a compact disc, or the like.

The above descriptions are merely exemplary embodiments of the present application, but are not intended to limit the present application. Any modifications, equivalent replacements, improvements, and the like made within the spirit and principles of the present application should be included within the protection scope of the present application.

1. A control assembly, used for controlling a display panel and configured to:
acquire brightness parameters of sub-pixels of a plurality of colors in a display region of the display panel in an (n−1)^{th} sensing cycle, wherein brightness parameters of sub-pixels having any one of the plurality of colors are positively correlated with a sub-pixel parameter of the sub-pixels having the any one of the plurality of colors in the sensing cycle; the sub-pixel parameter is positively correlated with at least one of a quantity of lightened sub-pixels and a gray-scale value about the lightened sub-pixels; the sensing cycle comprises a duration of a plurality of frames during a display of the display panel; and n is an integer greater than or equal to 1;
determine a target color based on the brightness parameters of sub-pixels of the plurality of colors; and
acquire target compensation parameters of sub-pixels having the target color in an n^{th} sensing cycle; and compensate for the sub-pixels having the target color based on the target compensation parameters.

2. The control assembly according to claim 1, further configured to:
acquire first compensation parameters of sub-pixels having a first color of the plurality of colors in the (n−1)^{th} sensing cycle; and compensate for the sub-pixels having the first color based on the first compensation parameters; and
acquire second compensation parameters of sub-pixels having a second color of the plurality of colors in an (n+1)^{th} sensing cycle, wherein the second color is different with the first color; and compensate for the sub-pixels having the second color based on the second compensation parameters.

3. The control assembly according to claim 2, wherein the display region comprises x rows of sub-pixels; the sensing cycle comprises a duration of a*x frames; and a is an integer greater than or equal to 1.

4. The control assembly according to claim 3, configured to:
acquire target compensation parameters of one row of sub-pixels having the target color in the display region in one frame of the n^{th} sensing cycle; and compensate for the one row of sub-pixels having the target color based on the target compensation parameters of the one row of sub-pixels.

5. The control assembly according to claim 1, wherein the display region comprises a plurality of display sub-regions; and each of the display sub-regions comprises a plurality of rows of sub-pixels; and
the control assembly is configured to:
acquire brightness parameters of sub-pixels having each color in each of the plurality of display sub-regions in the (n−1)^{th} sensing cycle;
determine a display sub-region target color of each of the plurality of display sub-regions, wherein the display sub-region target color is a color of a sub-pixel having a greatest brightness parameter in each display sub-region; and
acquire compensation sub-parameters of sub-pixels having the display sub-region target color in each display sub-region in the n^{th} sensing cycle; and compensate for the sub-pixels having the display sub-region target color in each display sub-region based on the compensation sub-parameters.

6. The control assembly according to claim 1, wherein the display region comprises a plurality of display sub-regions; and each of the display sub-regions comprises a plurality of rows of sub-pixels; and
the control assembly is configured to:
acquire brightness parameters of sub-pixels having each color in each of the plurality of display sub-regions in the (n−1)^{th} sensing cycle;
determine a first color display sub-region in the plurality of display sub-regions, wherein the first color display sub-region is a display sub-region in which a sub-pixel having a first color has a greatest brightness parameter; and
acquire compensation sub-parameters of sub-pixels having the first color in the first color display sub-region in the n^{th} sensing cycle; and compensate for the sub-pixels having the first color in the first color display sub-region based on the compensation sub-parameters of the sub-pixels having the first color.

7. The control assembly according to claim 6, further configured to:
determine a second color display sub-region in the plurality of display sub-regions, wherein the second color is different with the first color and the second color display sub-region is a display sub-region in which a sub-pixel having a second color has a greatest brightness parameter; and
acquire compensation sub-parameters of sub-pixels having the second color in the second color display sub-region in the n^{th} sensing cycle; and compensate for the sub-pixels having the second color in the second color display sub-region based on the compensation sub-parameters of the sub-pixels having the second color.

8. The control assembly according to claim 1, wherein the plurality of display sub-regions comprise at least one low-brightness display sub-region; and for each of the plurality of colors, none of sub-pixels having the color in the low-brightness display sub-region has a greatest brightness parameter among sub-pixels having the color in the display region; and
the control assembly is further configured to:
acquire compensation sub-parameters of sub-pixels having a preset color in the at least one low-brightness display sub-region in the n^{th} sensing cycle; and compensate for the sub-pixels having the preset color based on the compensation sub-parameters of the sub-pixels having the preset color.

9. The control assembly according to claim 5, wherein quantities of rows of sub-pixels comprised in the plurality of display sub-regions are the same.

10. The control assembly according to claim 1, further configured to:
determine whether the brightness parameters of the sub-pixels of the plurality of colors comprise a brightness parameter of a sub-pixel having the target color that is greater than a brightness parameter threshold; and
in response to there being one brightness parameter of a sub-pixel having the target color that is greater than the brightness parameter threshold, acquire target compensation parameters of the sub-pixels having the target color in an n^{th} sensing cycle; and compensate for the sub-pixels having the target color based on the target compensation parameters.

11. The control assembly according to claim 10, wherein the display region comprises s display sub-regions; quantities of rows of sub-pixels comprised in the display sub-regions are the same; and the control assembly is further configured to:
in response to brightness parameters of sub-pixels of the s target colors are greater than the brightness parameter threshold being comprised, acquire target compensation parameters of sub-pixels of the s target colors in a first display sub-region of the s display sub-regions in the n^{th} sensing cycle; and compensate for the sub-pixels of the s target colors in the first display sub-region based on the target compensation parameters.

12. The control assembly according to claim 11, further configured to:
acquire target compensation parameters of sub-pixels of the s target colors in a second display sub-region of the s display sub-regions in an (n+2)^{th} sensing cycle, wherein the second display sub-region is different with the first display sub-region; and compensate for the sub-pixels of the s target colors in the second display sub-region based on the target compensation parameters.

13. The control assembly according to claim 5, wherein the display region comprises a plurality of display sub-regions; and a brightness parameter of a sub-pixel having a first color of the plurality of colors in the display sub-region satisfies:
$${M}^{′} = q * {d}^{′} * {y}^{′} ,$$
wherein
M′ is the brightness parameter of the sub-pixel having the first color in the display sub-region; d′ is a quantity of lightened sub-pixels having the first color in the display sub-region; y′ is a sum of gray-scale values of the lightened sub-pixels having the first color in the display sub-region; q is a weight parameter of the display sub-region; and the weight parameter is negatively correlated with a distance between the display sub-region and a center of the display region.

14. The control assembly according to claim 1, wherein the target color is a color of a sub-pixel which has a greatest brightness parameter in the sub-pixels of the plurality of colors.

15. The control assembly according to claim 1, wherein a brightness parameter of a sub-pixel having a first color of the plurality of colors in a specified region satisfies:
$$M = d * y ,$$
wherein
M is the brightness parameter of the sub-pixel having the first color in the specified region; d is a quantity of lightened sub-pixels having the first color in the specified region; y is a sum of gray-scale values of the lightened sub-pixels having the first color in the specified region; and the specified region is a part or all of the display region.

16. The control assembly according to claim 1, comprising a timing controller.

17. A method for controlling a display panel, used for controlling the display panel and comprising:
acquiring brightness parameters of sub-pixels of a plurality of colors in a display region of the display panel in an (n−1)^{th} sensing cycle, wherein brightness parameters of sub-pixels having any one of the plurality of colors are positively correlated with a sub-pixel parameter of the sub-pixels having the any one of the plurality of colors in the sensing cycle; the sub-pixel parameter is positively correlated with at least one of a quantity of lightened sub-pixels and a gray-scale value about the lightened sub-pixels; the sensing cycle comprises a duration of a plurality of frames during a display of the display panel; and n is an integer greater than or equal to 1;
determining a target color based on the brightness parameters of sub-pixels of the plurality of colors; and
acquiring target compensation parameters of the sub-pixels having the target color in an n^{th} sensing cycle; and compensating for the sub-pixels having the target color based on the target compensation parameters.

18. The method according to claim 17, wherein further comprising:
acquiring first compensation parameters of sub-pixels having a first color of the plurality of colors in the (n−1)^{th} sensing cycle; and compensating for the sub-pixel having the first color based on the first compensation parameter; and
acquiring second compensation parameters of sub-pixels having a second color of the plurality of colors in an (n+1)^{th} sensing cycle, wherein the second color is different with the first color; and compensating for the sub-pixel having the second color based on the second compensation parameter.

19. A display apparatus, comprising the control assembly according to claim 1 and a display panel, wherein the control assembly is connected to the display panel.

20. A display apparatus, comprising a control assembly and a memory, wherein the memory stores at least one instruction, at least one program, a code set, or an instruction set; and the method according to claim 17 is implemented by the control assembly when the at least one instruction, the at least one program, the code set, or the instruction set is loaded and executed by the control assembly.
